(19) United States
(12) Patent Application Publication
(10) Pub. No.: US 2025/0126104 A1
(43) Pub. Date: Apr. 17, 2025

(54) CONTENT VALIDATION NETWORK AND ASSOCIATED METHODS

(71) Applicant: Total Recall Inc., Gig Harbor, WA (US)

(72) Inventor: Andrew S. DODGE, Auburn, WA (US)

(73) Assignee: Total Recall Inc., Gig Harbor, WA (US)

(21) Appl. No.: 18/929,203

(22) Filed: Oct. 28, 2024

Related U.S. Application Data
(63) Continuation-in-part of application No. 18/382,592, filed on Oct. 23, 2023, now Pat. No. 12,132,713.
Application No. 18/382,592 is a continuation of application No. 17/990,665, filed on Nov. 19, 2022.
Application No. 17/990,665 is a continuation of application No. 17/592,569, filed on Feb. 4, 2022, now abandoned.
(60) Provisional application No. 63/254,805, filed on Oct. 12, 2021.

(51) Int. Cl. H04L 9/40

(52) U.S. Cl. CPC H04L 63/0442; H04L 63/0823

(57) ABSTRACT

A method and system for securing digital content are disclosed. The method includes decoding inline content using an author's cryptographic key, authenticating a user for online systems with a current patent, and receiving cryptographic proof of identity at a server. It also involves cryptographically changing the border of the digital content based on a content signature, creating segmented checksums for streaming video and audio data, and adapting to support various data formats beyond XML. The system comprises a processor and memory storing instructions to perform these functions.

### FIELD OF THE INVENTION

The present invention relates to systems and methods for validating and certifying content posted on the internet. In particular, the present invention relates to a content validation network and associated methods.

### BRIEF DESCRIPTION OF THE DRAWINGS

FIG. 1 is a block diagram overview of the content validation network according to an embodiment of the invention.

FIG. 2 is a flowchart illustrating a certificate generation engine within the content validation network illustrated in FIG. 1.

FIG. 3 is a flowchart illustrating a signature engine within the content validation network illustrated in FIG. 1.

FIG. 4 is a flowchart illustrating a display engine within the content validation network illustrated in FIG. 1.

FIG. 5 is a flowchart illustrating a certificate status engine within the content validation network illustrated in FIG. 1.

FIG. 6 is a flowchart illustrating a stamp engine within the content validation network illustrated in FIG. 1.

FIG. 7 represents html metadata generated by the content validation network according to an embodiment of the invention.

FIG. 8 is a demonstrative representation of html metadata generated by the content validation network according to an embodiment of the invention.

FIG. 9 is a demonstrative representation of displayed content generated by the content validation network according to an embodiment of the invention.

### DETAILED DESCRIPTION OF THE INVENTION

The present invention will now be described in detail with reference to the accompanying drawings. The embodiment descriptions are illustrative and not intended to be limiting in any way. Other embodiments of the invention will readily suggest themselves to persons with ordinary skill in the art after having the benefit of this disclosure. Accordingly, the following embodiments are set forth without any loss of generality and without imposing limitation upon the claimed invention.

Directional terms such as “above” “below” “upper” “lower” and other like terms are used for the convenience of the reader in reference to the drawings. Additionally, the description may contain terminology to convey position, orientation, and direction without departing from the principles of the present invention. Such positional language should be taken in context of the represented drawings.

Quantitative terms such as “generally” “substantially” “mostly” and other like terms are used to mean that the referred object, characteristic, or quality constitutes a majority of the referenced subject. Likewise, use of the terms such as first and second do not necessarily designate a limitation of quantity. Such terms may be used as a method of describing the presence of at least one of the referenced elements or may provide a means of differentiating orientation. The meaning of any term within this description is dependent upon the context within which it is used, and the meaning may be expressly modified.

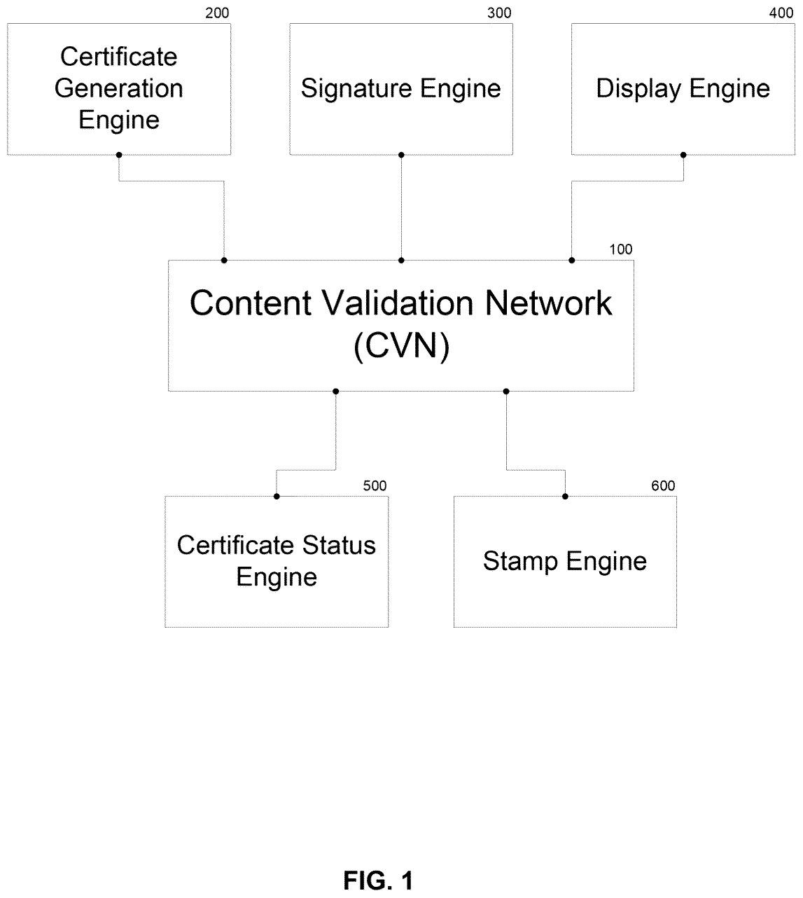

Referring now to FIG. 1, the content validation network 100, hereinafter referred to as the network 100, may include a certificate generation engine 200, a signature engine 300, a display engine 400, a certificate status engine 500 and a stamp engine 600.

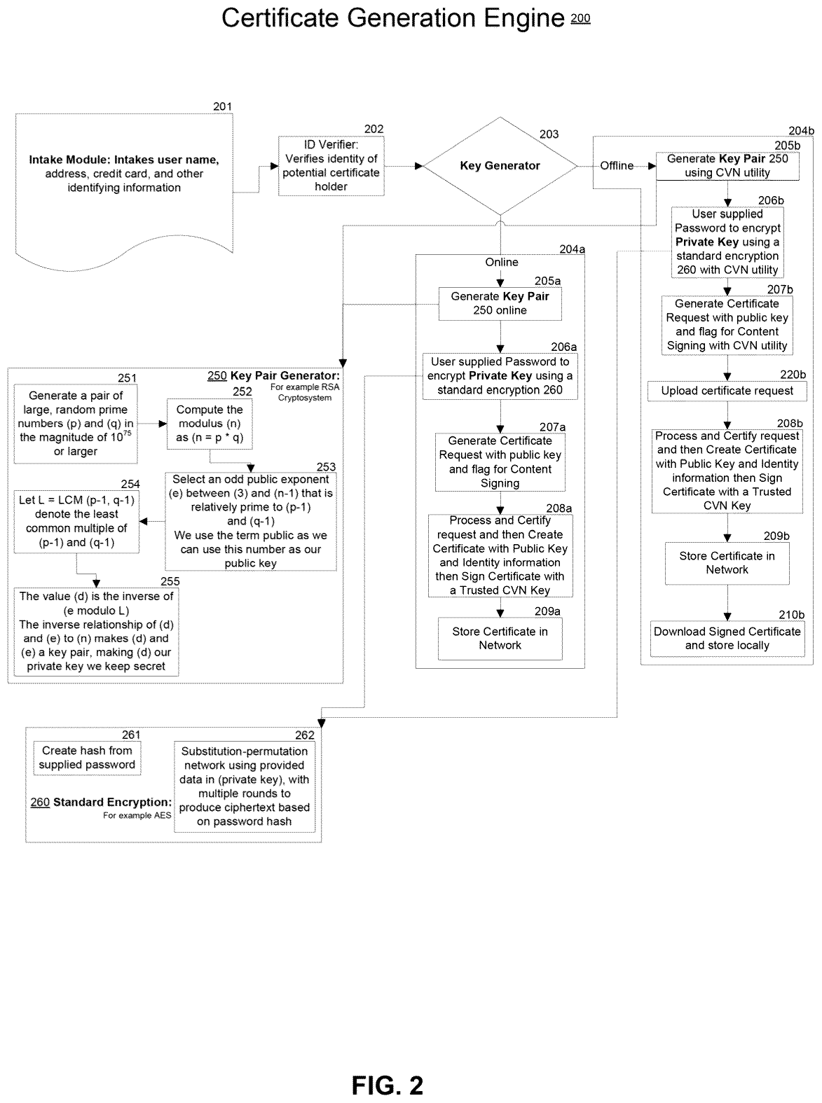

FIG. 2 illustrates the certificate generation engine 200 in more detail. This may be the initial stage of the network 100 generating a certificate once a user has been authenticated. A user may then use their certificate to sign and authenticate content created by that user.

As such, an initial component of the certificate generation engine 200 may be an intake module 201 that may request information from a user to begin initializing the network 100 to that user. By way of non-limiting example, user intake information may include name and contact information, credit card and state identification data, as well as other personal or business information. Once placed into the system 100, an ID verifier 202 may ensure that that the user is in fact who they represent themselves to be by cross-referencing the intake information against public or private databases. By way of non-limiting example, a user may be cross referenced against bank records, state identification records, Dun and Bradstreet, IRS records, and secretary of state records.

A network 100 API may allow for access to these databases and a comparison algorithm may allow for the submitted information to be cross referenced against what was scraped from these databases. Once a pre-established comparison threshold has been met between user submitted information and pulled database information, a positive flag may be passed to a key generator 203 for processing. Conversely, should the pre-established threshold not be met, a negative flag may be passed to the key generator 203 and the user may not be certified.

The Key Pair Generator 250, by way of non-limiting example, demonstrates how public-key cryptography keys may be generated. Public-key cryptography, or asymmetric cryptography, is a cryptographic system that uses pairs of keys. Each pair consists of a public key (which may be known to others) and a private key (which may not be known by anyone except the owner). The generation of such key pairs depends on cryptographic algorithms which are based on mathematical problems termed one-way functions. Effective security requires keeping the private key private; the public key can be openly distributed without compromising security. The key generator 203 creates both a public key and a private key to authenticate a user and create a certificate. With public-key cryptography, robust authentication is possible. A user can combine a message with a private key to create a short digital signature on the message. Anyone using the author's corresponding public key can combine that message with a claimed digital signature. If the signature matches the message, the origin of the message is verified. In cryptography, a public key certificate, also known as a digital certificate or identity certificate, is an electronic document used to prove the ownership of a public key. The certificate includes information about the key, information about the identity of its owner (called the subject), and the digital signature of a key trusted by the network 100 that has verified the certificate's contents (called the issuer), If the signature is valid, the date range of the certificate matches the publication date, the issuer's digital signature is valid, and the issuer is trusted by the network 100, then it can use that key to authenticate that a message was digitally signed by the author. A public-key cryptography algorithm may use prime factorization as the trapdoor one-way function.

$$Modulus ( n ) = PrimeRandom 1 ( p ) * PrimeRandom 2 ( q ) \qquad Equation 1$$

In 251 this may define a pair of large random prime numbers, for example (p) and (q), in the magnitude of 10⁷⁵ or larger. A Modulus 252 may be computed (n) as a product of (p) and (q) mathematically with equation 1, (n=p*q). An odd public exponent 253 may be selected (e) between (3) and (n−1) that is relatively prime to (p−1) and (q−1). This is tagged as public and acts as the public key available to anyone. The network 100 incorporates this with signed content.

$$L = LCM ( p - 1 , q - 1 ) \qquad Equation 2$$

$$PrivateKey ( d ) = inverse of ( PublicKey ( e ) modulo L ) \qquad Equation 3$$

In FIG. 254 continuing with Equation 2, L=LCM (p−1, q−1) denoting the least common multiple of (p−1) and (q−1). Demonstrated in 255 the private key value (d) is the inverse of (e modulo L), equation 3. The inverse relationship of (d) and (e) to (n) makes (d) and (e) a key pair, making (d) the secret private key. This inverse relationship gives the ability to use one key to perform a function and only the inverse key can perform a corresponding function for the desired result.

$$Equation 4$$

$$DigitalSignature ( s ) = {MessageHash ( m )}^{PrivateKey ( d )} ( mod ( Modulus ( n ) )$$

$$Equation 5$$

$$MessageHash ( m ) = {DigitalSignature ( s )}^{PublicKey ( e )} ( mod ( Modulus ( n ) )$$

By way of non-limiting example, a message may be converted to a number through a hash function (m). When (m) is taken to the d exponent (d being the private key) then mod by (n) the digital signature (s) is produced Equation 4. This can then only be verified by the inverse function taken by (m) to the (e public key) exponent and then mod by (n) Equation 5. This produces the message hash (m). This ensures that the only feasible author who signed the message hash must have had the private key (d). Both (p) and (q) are large enough random prime numbers that attempting to reverse engineer them through factorization is a practical impossibility with current computing technology.

Symmetric standard encryption 260, by way of non-limiting example, may be used to encrypt the private key for secrecy using a standard symmetrical encryption for example AES, and a private key password may either be created by a user or automatically generated. By way of non-limiting example, using AES a hash may be created from the supplied password to be a specific size 261. Then a substitution-permutation network 262 may be used with the data to be protected, in this case the private key, with multiple rounds to produce ciphertext based on the password hash. This encryption protects the private key with a password that is practically impossible to decrypt using current technology.

The key generator 203 may actuate through either an online key generator 204a or an offline key generator 204b. The Key Pair may be generated and maintained via centralized cloud server for online signing purposes or may be maintained offline via an installed computing device utility for offline signing purposes.

The online key pair generator 205a may utilize the cloud server to create the key pair using Key Pair Generator 250.

As block 206 suggests, the private key may be encrypted for secrecy using a Standard Symmetrical Encryption 260. This adds an additional layer of security specifically to the private key. Therefore, the private key may include multilayer protection including a password encryption specific to the private key that is required for a user to actually utilize the private key, a login required to access the online network 100 where it is stored, and additional two factor authentication such as a cell phone code sent via another network like text messaging.

As block 207a illustrates, when a logged in user that has either not previously been certified or has an expired certificate wishes to publish verified online content, a request for a certificate may be generated with a flag for content signing 207a. This request may be sent with user identifying information along with the user's public key and the (n) modulus that corresponds to their private key from step 205. The network 100 validates the user based on the information supplied with their login account 208a. If found valid and trustworthy, the network 100 issues an official network certificate with information identifying the user, a public key and the (n) modulus that the user provided in step 207a. A flag is then set in the certificate allowing it to be used for content signing purposes.

As shown by block 208a, the network certificate now includes the identifying information, the public key, and modulus therein to serve as a public facing identification of the user. The certificate is then signed with a private key trusted by the network 100 so the certificate can then be authenticated by everyone as trusted by the network 100. This official network certificate, which is stored within the network 100, is what may be used to validate a logged in user's content 209a intended for online publishing.

The offline generator 205b may utilize a utility from the network 100 to create the key pair using Key Pair Generator 250. Additionally, as block 206b suggests, the private key may be encrypted for secrecy offline using a Standard Symmetrical Encryption 260.

A request for a certificate may be generated with a flag for content signing 207b. This request is created with a subject equaling user identifying information along with the user's public key and the (n) modulus that corresponds to their private key from step 205b. This request is then uploaded 220b to the login account created for 201. The network 100 validates the user based on the information supplied with their login account 208b. If found valid and trustworthy, the network 100 issues an official network certificate containing a subject equaling information identifying the user, a public key and the (n) modulus that the user provided in step 207a and a flag is set in the certificate allowing it to be used for content signing purposes. The network certificate encapsulates the information therein to serve as a public facing identification of the user 208b. The certificate is then signed with a private key trusted by the network 100 so the certificate can then be authenticated by everyone as trusted by the network 100. This official network certificate, which is stored within the network 100, is what may be used to validate a logged in user's content 209b intended for online publishing. The certificate is then downloaded back to a network 100 Utility to be stored with the Private Key to be included when content is signed 210b.

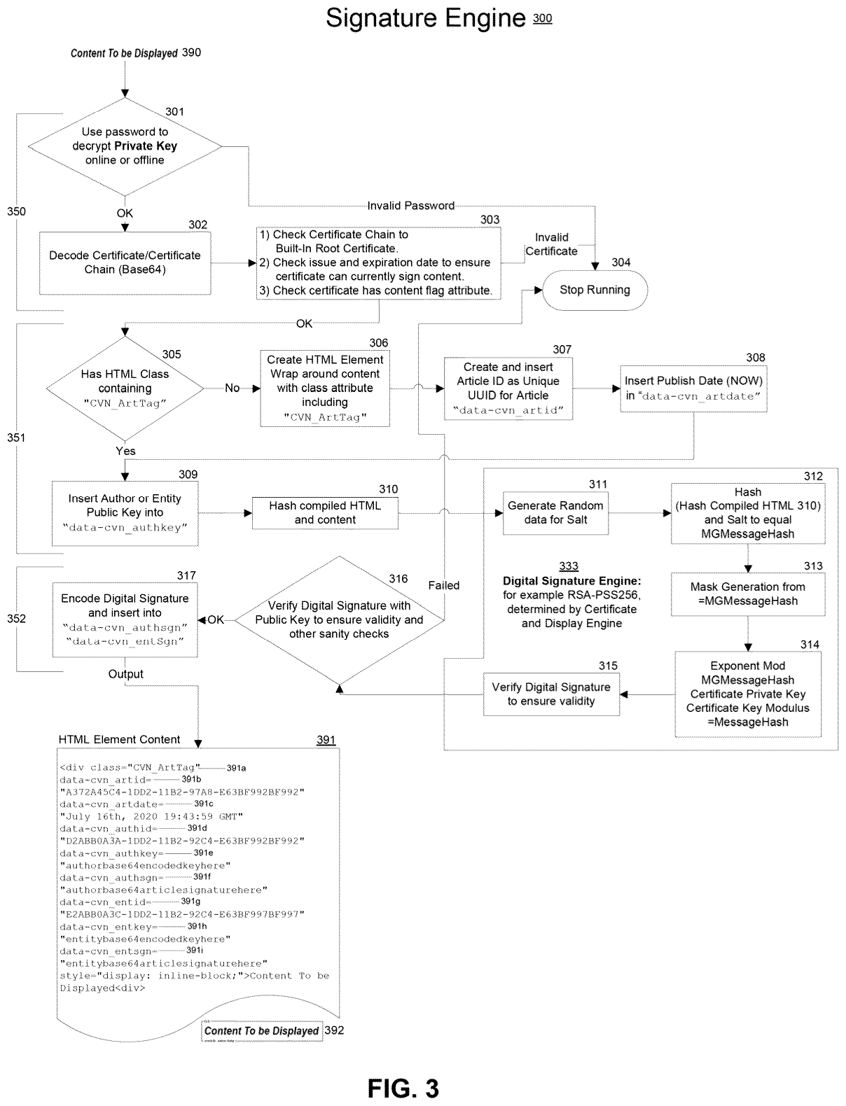

FIG. 3 is a flowchart that demonstrates the signature engine 300. The signature engine 300 may provide a user author the ability to digitally sign content using their private key and certificate and thereby provide proof that the content to be published could only have been authored by that user.

As shown, the initial stage 350 may include decrypting the user's private key using the password created from 206a, 206b and accessing the private key from 205a and 205b. If an incorrect password is used, then the network 100 may terminate the request 304. If a correct password is used then the network certificate may be decoded 302. By way of non-limiting example, the encoding to be removed may be base64. Base64 encoding is typically used to alter binary code data into a human readable transmittable data format, for example instead of ‘01000001’ a ‘QQ==’ can be substituted. Decoding base64 involves turning the human readable transmittable data into binary and encoding base64 involves turning binary into human readable transmittable data. Because binary cannot be directly implemented into HTML, decoding the certificate and the certificate chain is necessary. Therefore, the binary numbers are converted into a plain text format that can be included into an HTML web page.

Next, validation of the certificate may include three steps as depicted by block 303. First, a certificate check may be conducted to determine if the network certificate is in fact valid, is signed by a trusted private key implemented by the network 100, or has a lineage to a trusted private key implemented by the network. Second, the issue and expiration date of the network certificate may be cross referenced with the current date to ensure the network certificate has not expired. This enables the user to publish content with a current date. Third, a check may be made to determine if the network certificate contains the necessary content signing flag attribute embedded therein needed for content signing. If the certificate does not pass these validity checks, the request may be terminated 304 for not including an acceptable network certificate and the user content may not be validated and signed accordingly.

The next phase of the signature engine 300 may include an html compiler 351 that may wrap and label the content to be published with particularized html tags if not already included with the content.

First, block 305 indicates that a check may be conducted to determine if the content already includes the html class tag identifying that it has already been validated by the network 100. By way of non-limiting example, this tag may be labeled “CVN-ArtTag”. If the content already includes the tag, insertion of the tag is not necessary and instead the content will be cross-signed with an additional digital signature. If the content does not include the tag, at this juncture it may continue through to have the tag added 306. The content may be given a unique article ID (UUID or universally unique identifier) and placed within an html tag 307. By way of non-limiting example this tag may be labeled “data-cvn_artid”. The content may then be given the current time and date as the published date to be tagged in html 308. By way of non-limiting example, this tag may be labeled “data-cvn_artdate”.

Block 309 indicates that the author or entity public key may be inserted either after block 305 if the “CVN_ArtTag” is present or after step 308. By non-limiting example, this may be a “data-cvn_authid” tag, which is an ID embedded in the certificate, and then used with the base64 encoded certificate and chain that may be inserted by way of non-limiting example in the “data-cvn_authkey” attribute. As block 310 indicates, the compiled HTML content is now hashed. That is, a cryptographic hash is created based on the entire HTML element compiled to this point.

Block 333 the digital signature, supporting the Signature Engine 300, may utilize by way of non-limiting example RSAPSS256. Block 333 indicates that the compiled HTML may enter the digital signature engine to add a digital signature to the content to be posted. First, a random value known as a salt is generated to add to the hash created in block 310. The salt ensures that the digital signature is varied upon each call. It also adds an extra layer of security preventing the ability to falsify a digital signature. As indicated by block 312, an additional layer of hashing is added to the previous hash from 310 and the salt created in 311 to further complicate any attempt to falsify a digital signature.

Block 313 shows that the hash from 312 may then be masked along with the salt from 311 to provide a method for the network 100 to verify the digital signature. The digital signature is created using exponent math, the mask 313, the private key 301 and the modulus.

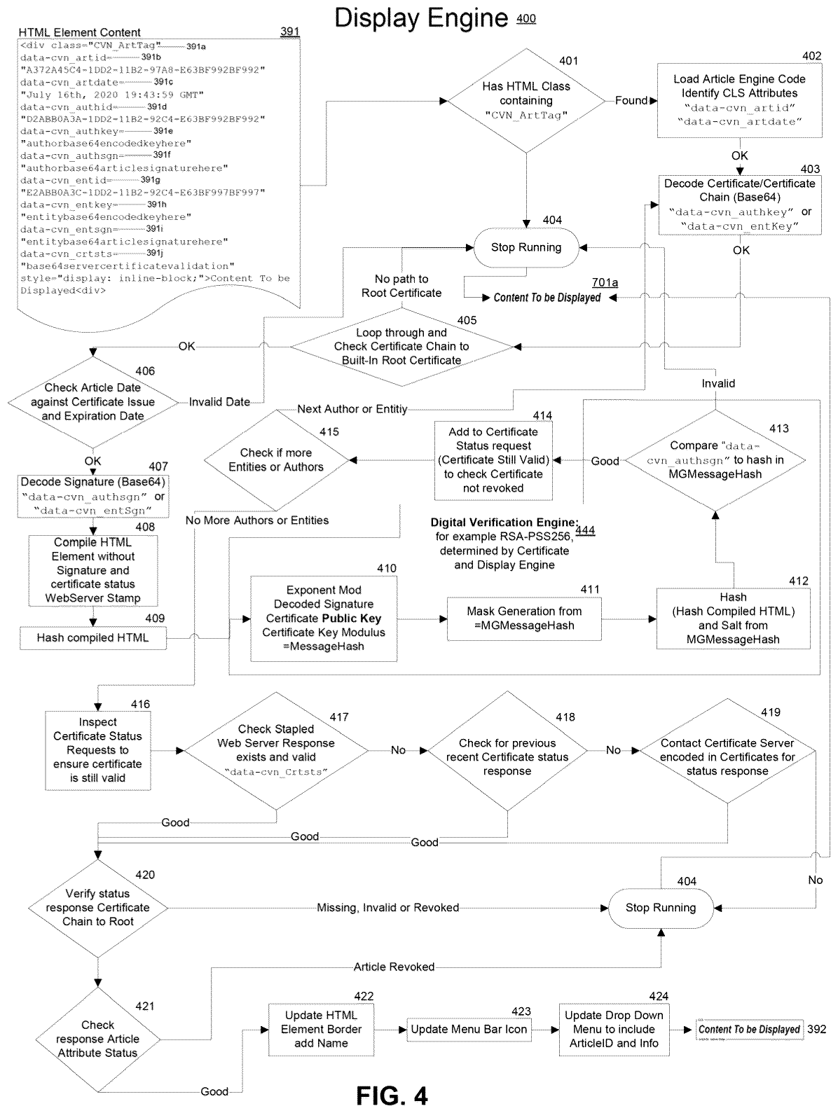

Blocks 315 and 316 note that the digital signature may be verified following the procedures outlined hereafter in FIG. 4. The digital signature may be verified with the public key to ensure its validity and may be run through other sanity checks as well. If the digital signature verification fails, the network 100 directs the request to a STOP and effectively ends the program 304. However, if it does not fail, then as block 317 indicates, the digital signature may be encoded and inserted by way of non-limiting example into “data-cvn_authsgn” or “data-cvn_entsgn” depending on author or entity for later validation with the Display Engine 400. By way of non-limiting example, the HTML output may resemble the display in block 391.

FIG. 4 illustrates the display engine 400 that inspects signed certified content and displays it for viewing showing evidence that the content posted could only have been created by the author in 300. Beginning with block 401, the network 100 may check an entire webpage or any other stream of data in any application running through the network 100 to locate a class containing, by way of non-limiting example, the “CVN_ArtTag” tag. If found, block 402 indicates that the code engine may be loaded into memory to perform validation steps. This keeps the memory profile low while maintaining a high throughput until validation is needed. If not found, the program is instructed to stop running 404.

Next, the author identifier, by way of non-limiting example, attribute may be labeled “data-cvn_authid” and may be fetched to decode the author key or author key chain, by way of non-limiting example, from the “data-cvn_authkey” attribute, 403. Block 405 indicates that the author certificate or author certificate chain is checked to ensure the certificate is signed by private keys trusted by the network 100 with a lineage back to an originally produced network 100 root certificate. Box 406 indicates a check for the article date, by way of non-limiting example, this attribute may be labeled “data-cvn_artdate” and is used to see that it falls between the certificate issue date and certificate expiration date. A certificate may be renewed each year to publish new work. However, the original certificate is still in place to match the time period the work digitally signed using that certificate was published and falls within the “data-cvn_artdate” attribute. As box 407 suggests, by way of non-limiting example, the “data-cvn_authsgn” attribute may be decoded to retrieve the content signature. Box 408 indicate that the HTML then may be compiled removing the author's signature, by way of non-limiting example, this attribute may be labeled “data-cvn_authsgn” and removing any co-author or entity-cross signed attributes. Furthermore, by way of non-limiting example, an attribute labeled “data-cvn_crtsts” containing a previous stamped certificate status response from the stamp engine 600, is removed if there is one. However, with the author's attributes left included. As indicated by box 409, a cryptographic hash based on the compiled HTML from 408 is created. The HTML is then put through the digital signature engine 444.

The digital verification engine 444, supporting the Display Engine 400, may utilize by way of non-limiting example RSAPSS256. The digital verification engine 444 performs the inverse operation of the digital signature engine 333 from FIG. 3.

First, as block 410 indicates, using exponent math, the decoded signature from 407, the decoded certificate's Public Key, and the decoded certificate's modulus from 403, the MessageHash is created using Equation 4. The MessageHash is then run through the Mask Generation function in order to split the salt from the digital signature hash, 411. The compiled HTML from 409 and the salt retrieved from 411 is then hashed, 412. Block 413 indicates that the decoded, by way of non-limiting example, “data-cvn_authsgn” is compared with the hash generated from 412. If they are not the same then the network is prompted to terminate action 404. If they are equal than the network 100 may continue processing. Block 414 indicates that once the digital signature engine has completed, the HTML is added to the status request to ensure the author's certificate has not been revoked from the Certificate Generation Engine 200 that originally signed the author's certificate. Next, block 415 indicates that the article is checked to see if it is co-signed or cross signed. If so, then the network 100 loops back to block 403 to ensure they are also valid. In some embodiments, the network 100 may first check co-entities, then a single entity, then co-authors, then the original author.

Next, block 416 indicates that from each certificate the Certificate Generation Engine 200 used is located to get the Certificate Status Server Flag of each certificate. This dictates which server will be contacted to perform the Certificate Status Check 500. Next, block 417 indicates the network 100 checks to see if there is, by way of non-limiting example, a “data-cvn_crtsts” attribute. If so, the Certificate Status Response is decoded. As indicated by block 418, if no “data-cvn_crtsts” attribute exists, the network 100 checks to see if the Display Engine 400 previously cached a Certificate Status Response for this article. Block 419 indicates that if neither blocks 417 or 418 are true, then the network 100 sends the Certificate Status Request from 414 to the Certificate Status Server 500 found in block 416.

Block 420 indicates that the Certificate Status Response is checked to determine if there is a valid digital signature 444 reply that has been digitally signed 333 with a certificate with a lineage to a root certificate included with the Display Engine 400. Block 421 shows that it may then check the embedded network 100 Article Status Attribute to ensure the article is valid and has not been revoked by the author, co-author, or cross-signing entity.

At this point, as indicated by block 422, the displayed border around posted content may be updated to show that the content was successfully validated. Also included may be an opinion and the author's name or identifier. There is also a check here to ensure that if the item was copied that it includes the entire HTML Element so other Display Engines 400 can validate the content as well. An OnClick function may be used to bring up a Notification proving that the content has been validated. Block 423 denotes that at this stage by way of non-limiting example, a menu bar icon may be enabled for each signed content found giving the user information on how many articles are validated and ensuring that a border was not photographically added to spoof validation. Lastly, block 424 indicates that this information may be added for each item in a dropdown menu bar. Furthermore, a link with more information from the network 100 server may include more details about the author, accreditations, other articles, and inquiries about the content.

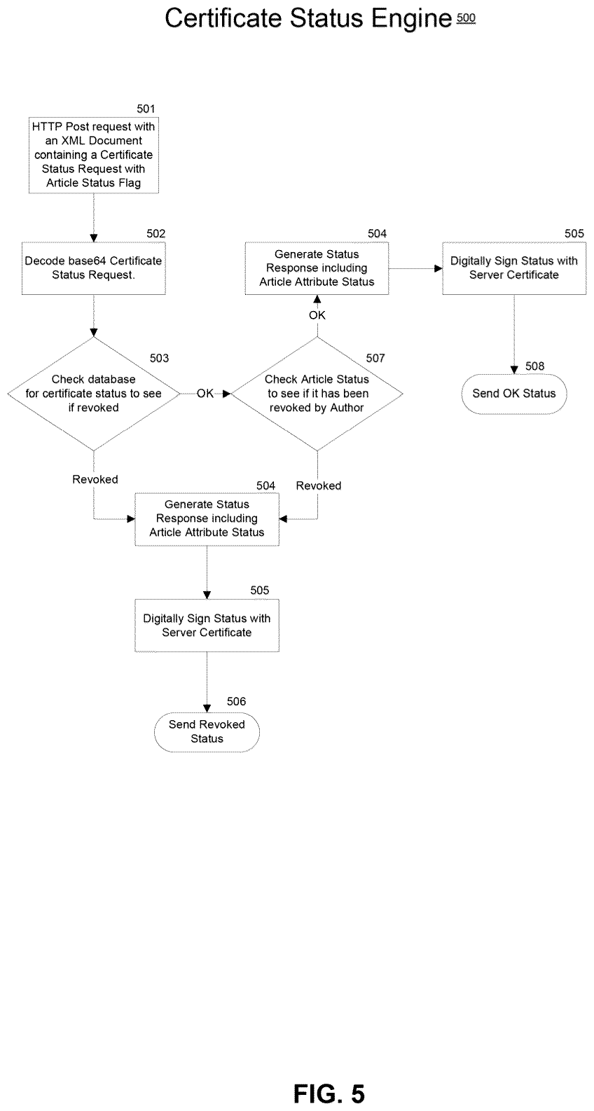

FIG. 5 depicts a certificate status engine 500 as may be embodied in the invention. The certificate status engine 500 may respond to status requests in order to validate the certificate from 200. It also checks the article status using an article status attribute to verify if the author revoked an article Digitally Signed from 300.

To begin, block 501 indicates that the system may respond to an HTTP post request of an XML Document with an included Certificate Status Request and may include an Article Status Flag to check both the status of the certificate and the article. Next, block 502 indicates it may decode the Certificate Status Request using Base64. Block 503 shows that the certificate database may be checked to determine whether the certificate has been revoked. Next, a status response is generated for the certificate and article, block 504. Block 505 indicates that the status is digitally signed 333 with the server certificate chain to enable the Display Engine 400 or the Stamp Engine 600 to validate a certificate Response Status. The response is sent out to the requestor to provide the Certificate Response Status that the certificate or article has been revoked, block 506. Block 507 indicates that the article status and certificate may be checked using the Display Engine 400 or the Stamp Engine 600 and allows the author to revoke an article if desired. Lastly, block 508 indicates that a successful certificate status and article status are then sent to the Display Engine 400 or the Stamp Engine 600. This ensures the Display Engine 400 or the Stamp Engine 600 has current validity information regarding the certificate and article. In some embodiments this may be within a cached window of twenty-four hours.

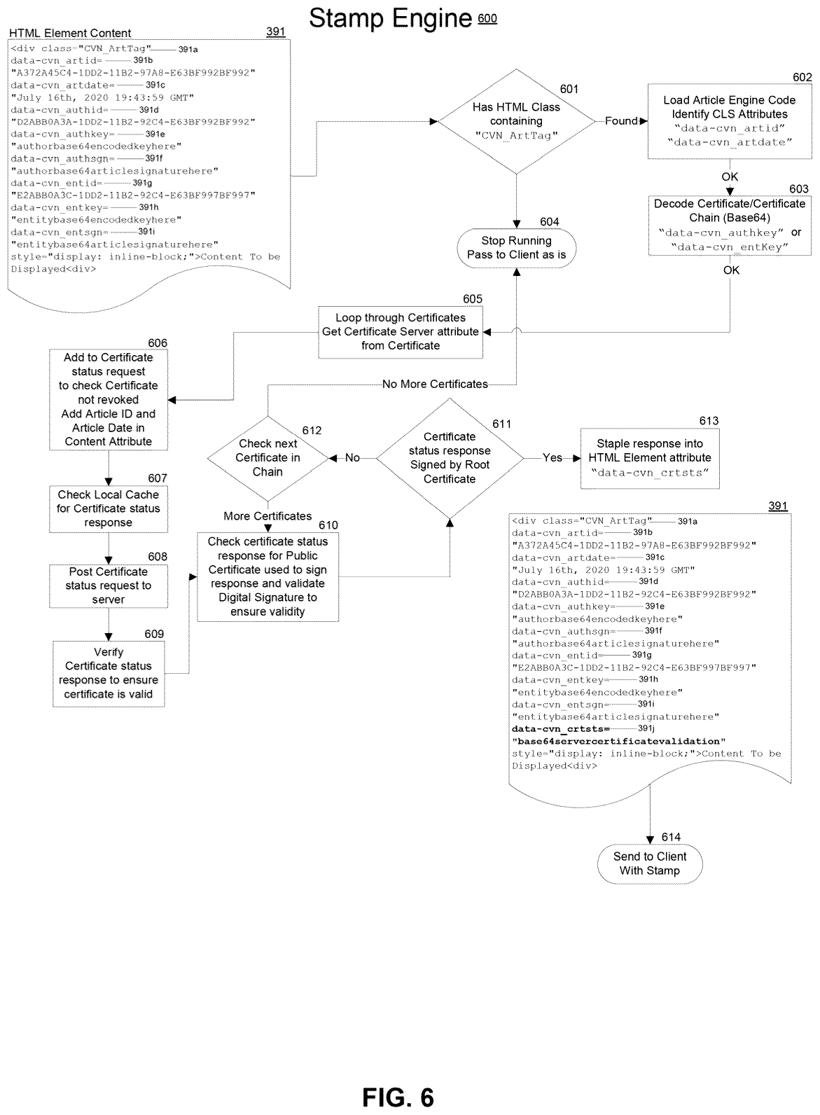

FIG. 6 illustrates the stamp engine 600 within the network 100. The stamp engine 600 allows a Web server to speed up the Display Engine 400 by checking the certificate status of 300. The Certificate Status Server Engine 500 initiates this action before sending the content out to all Display Engines 400. This in effect pre-caches the status of the Certificate Response thereby saving the Display Engines 400 from having to also contact the Certificate Status Server Engine 500 during that period.

Block 601 checks the entire page or any other stream of data in any application running validation from the network 100 and locates any class containing, by way of non-limiting example, the “CVN_ArtTag” tag if any exists. Block 602 illustrates that if the class containing “CVN_ArtTag” is found, then engine code is loaded into memory to perform the validation steps. This keeps the memory profile low and throughput high until validation is needed. Block 603 indicates that the network 100 then retrieves the author identifier, by way of non-limiting example, this attribute may be labeled “data-cvn_authid” and decodes the author key or author key chain, by way of non-limiting example, this attribute may be labeled “data-cvn_authkey”. If not found, the action is terminated 604. Block 605 illustrates the network 100 may then loop through to locate the Certificate Generation Engine 200 used for each certificate and gets the Certificate Status Server Flag of each certificate. This dictates the server to contact to perform the Certificate Status Request 500.

Block 606 indicates the flag is added to the Certificate Status Request in order to ensure the author's certificate has not been revoked from the Certificate Generation Engine 200 that signed the author's certificate. Block 607 indicates that the server cache is checked for the Certificate Status Response from the Certificate Generation Engine 200 Server found in 605 above. Then, block 608 shows that the Certificate Status Request is sent from 606 to the Certificate Generation Engine 200 Server found in 605. Block 609 indicates that the Certificate Status Response is checked to determine if there is a valid reply that has not been revoked. Next, block 610 shows that the Certificate Status Response is checked to ensure the digital signature is valid. Block 611 checks to see that the Certificate Status Response is a valid reply that has been digitally signed with a certificate chain from a root network 100 certificate included in the Web Server Status Stamp Engine 600. The next certificate in the chain is checked to ensure the entire chain, including all intermediate certificates, are signed properly, block 612. The Certificate Status Response is encoded from above with Base64 and, by way of non-limiting example, inserted into the attribute “data-cvn_crtsts”, block 613. Lastly, the completed HTML element is sent to the client to be validated with the Display Engine 400.

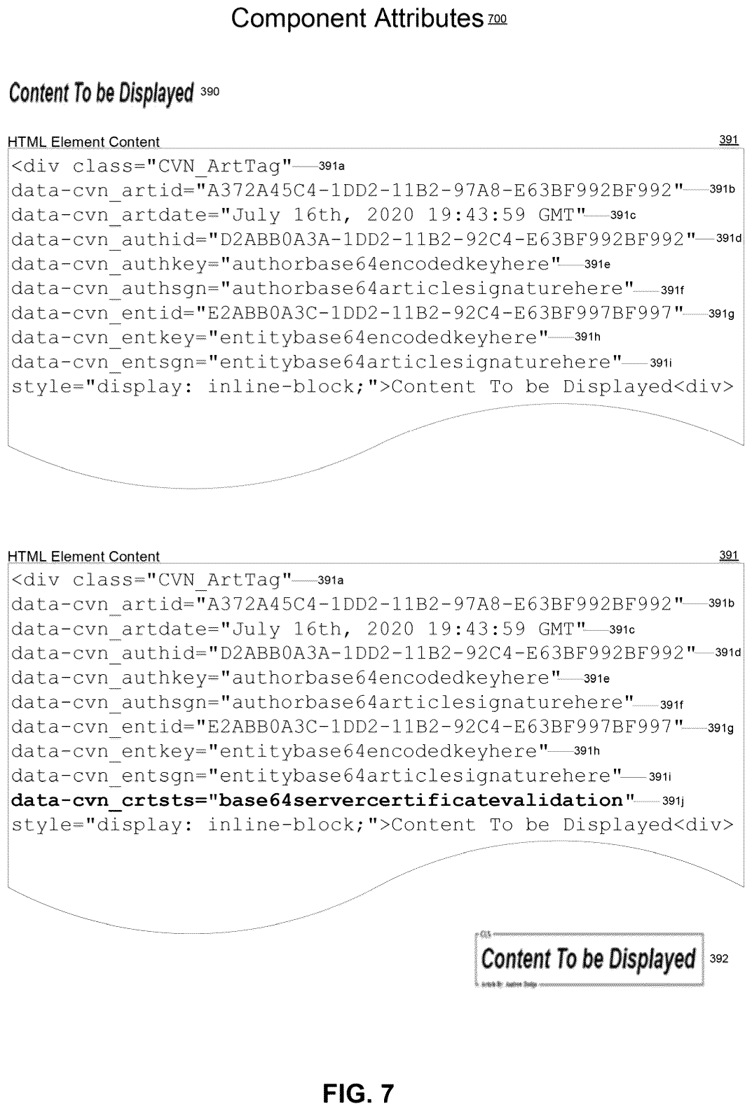

FIG. 7 is a representation of the HTML metadata generated by the content validation network according to an embodiment of the invention. FIG. 7 has all the same features of the embodiment shown in FIG. 3 except the limitation that the HTML metadata is generated by the content validation network. Plain digital content before any alterations that is waiting to be digitally signed is represented by 390. If a user views work that has been digitally signed by the Author as in FIG. 3, but the user is not using the network 100 they would see the digital content as plain 390 without any alterations. 391 is an HTML sample element with network 100 attributes for the Display Engine 400 to validate. 391a is an HTML Element with the class containing, by way of non-limiting example, “CVN_ArtTag” tag. 391b shows an article identifier, by way of non-limiting example, an attribute may be labeled “data-cvn_artid” containing a universal unique article identifier to identify content and differentiate it from other article content. 391c shows an article date, by way of non-limiting example, “data-cvn_artdate” to indicate unequivocally when the content was published by an author. 391d shows the author identifier, by way of non-limiting example, “data-cvn_authid” to easily decipher the identification of the author. 391e is an Author Key, by way of non-limiting example, “data-cvn_authkey”. This is the certificate of the author encoded in base64. It may also be a certificate chain which represents the certificates in a chained order tracing back to the ROOT certificate built into the network 100. The Author signature, by way of non-limiting example, “data-cvn_authsgn” is represented by 391f and is the attribute where the author's signature is embedded. This is encoded in base64, verifies that the Author signed the content and that the content has not been altered. 391g represents an entity identifier, by way of non-limiting example, “data-cvn_entid” to easily identify the entity. 391h is an example Entity Key “data-cvn_entkey” which is the certificate of the entity encoded in base64. Again, this may also be a certificate chain. 391i is an Entity signature, by way of non-limiting example, “data-cvn_entsgn” which is the attribute where the entity's signature is embedded. This is encoded in base64 and verifies that the specific entity signed this content. 391j is the certificate status response, by way of non-limiting example, an attribute may be labeled “data-cvn_crtsts” embedded by the Web server Stamp Engine 600 into the content to show that the Web server Stamp Engine 600 has pre-checked the certificate to ensure it and the article are current and valid. 391k represents Multiple Co-Authors repeated with a 2-9 behind each attribute for additional author co-signers. This provides a level of cross signing that gives an article more validity by having more digital signatures attached to the article. 3911 Multiple Co-Entities repeated with a 2-9 behind each attribute for additional co-entities. This may provide a level of cross-signing that may give an article more validity by having more digital signatures attached to the article. 392 is an HTML Sample displayed as being validated by the network 100.

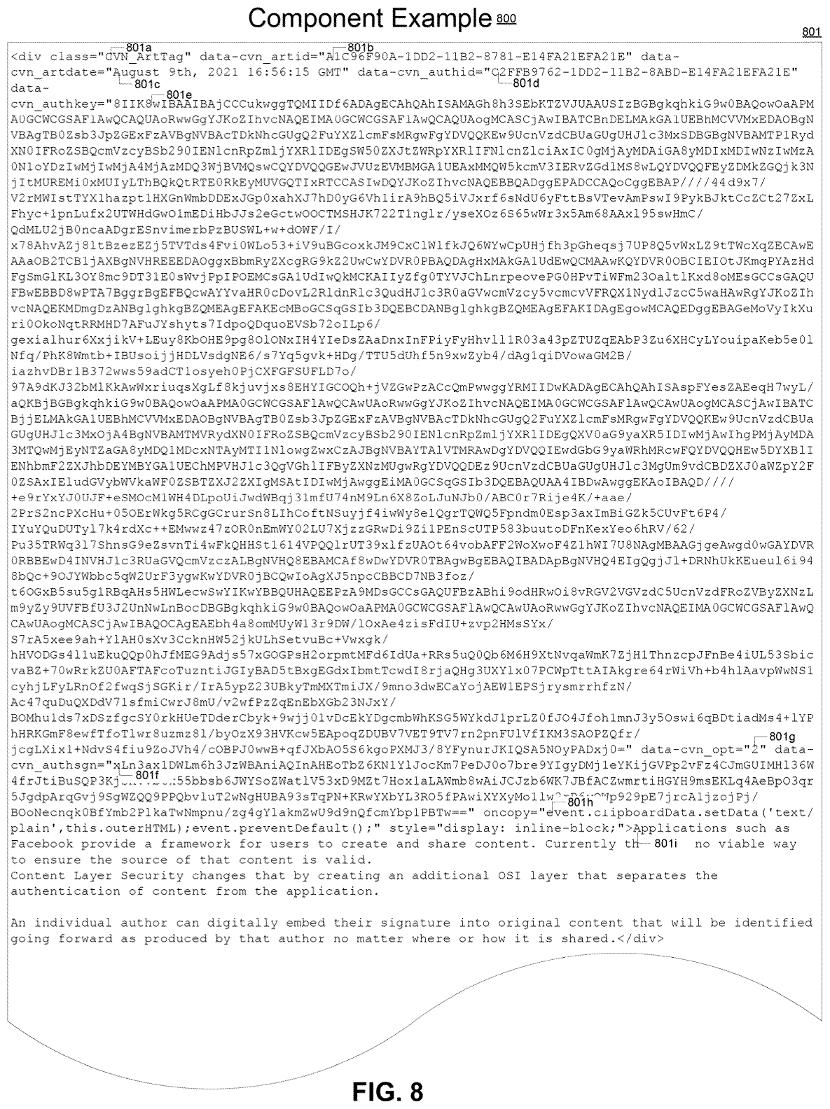

FIG. 8 is a demonstrative representation of html metadata generated by the network 100 according to an embodiment of the invention. 801 is an example with network 100 attributes complete. 801a is an HTML Element with the class containing, by way of non-limiting example, the “CVN_ArtTag” tag. 801b is an article identifier, by way of non-limiting example, attribute may be labeled “data-cvn_artid”. It contains a universal unique article identifier to identify content and differentiate it from other article content. 801c is an article date attribute “data-cvn_artdate” to indicate unequivocally when the content was published by an author. 801d is an Author identifier, by way of non-limiting example, “data-cvn_authid” to easily identify the author. 801e is an Author Key, by way of non-limiting example, “data-cvn_authkey”. This is the certificate of the author encoded in base64. It may also be a certificate chain which represents the certificates in a chained order tracing back to the ROOT certificate built into the network 100. 801f Author signature, by way of non-limiting example, “data-cvn_authsgn” is the attribute where the author's signature is embedded. This is encoded in base64. This is what ensures the content has not been altered and verifies that the Author signed this content. 801g is option data for an article, by way of non-limiting example, “data-cvn_opt”. This attribute indicates whether co-author's or entities can cross sign this article. 801h HTML Copy Event uses an “oncopy” function to ensure that if any text is copied from the article the entire HTML Element with all validation is copied and kept intact. Therefore, anytime content is copied and pasted the content is still validated by the network 100 and complete. 801i represents the actual raw content desired to be validated.

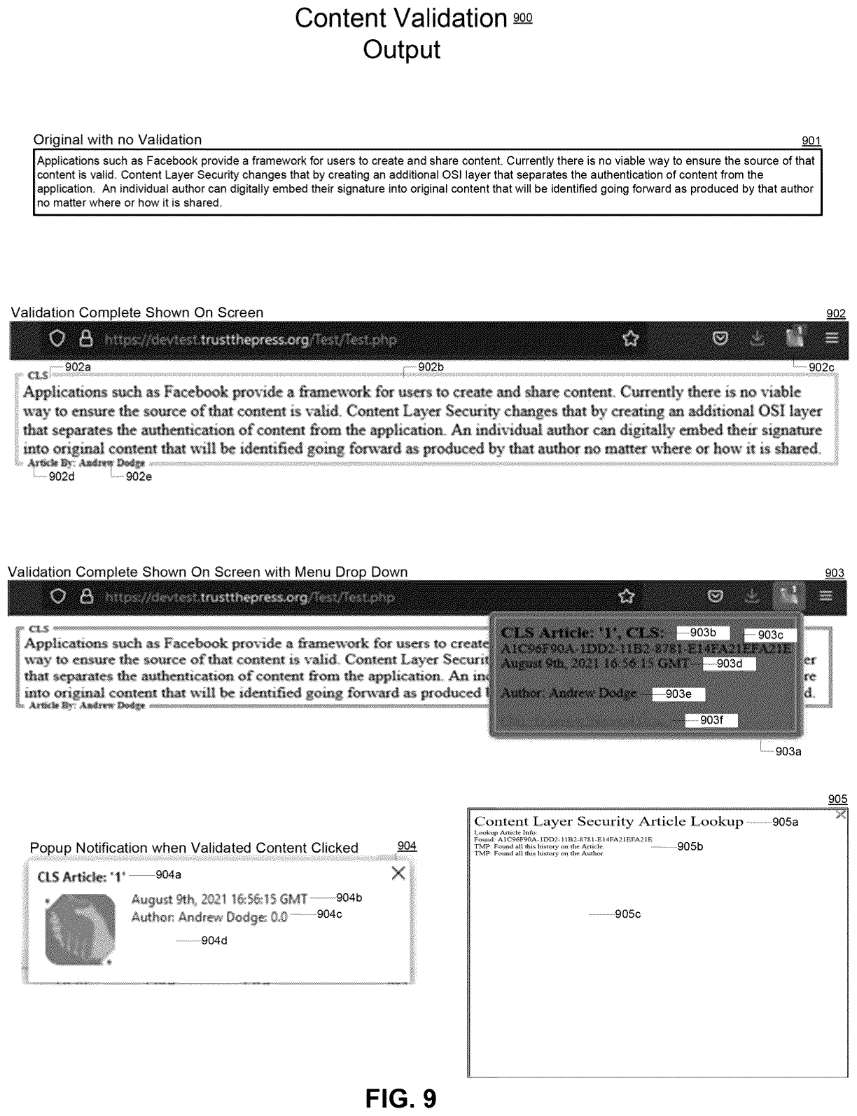

FIG. 9 is a demonstrative representation of displayed content generated by the network 100 according to an embodiment of the invention. 901 is an example of standard content before digitally signed. If a user views work that has been digitally signed by the Author as in FIG. 3, but the user is not using the network 100, they would see the digital content as plain 901 without any alterations. 902 is an example of content that has been digitally signed and validated by the network 100. The content may include a double border 902b. In some embodiments, this may include a “CVN” marking 902a to help indicate to a viewer that the content has been validated by the network 100. The display may also contain a menu bar icon 902c to provide additional user information. It may also provide proof that the validation is more than simply a graphic on the screen. The “article by” tag 902d and the author's name 902e may appear at the bottom of the content within the double border 902b as indicated. In some instances, this may be anonymous or indicated as an opinion rather than an author's name.

Example verified content with an additional dropdown 903a information is shown in 903. The dropdown 903a may include an article identification number 903b, an article identifier 903c, a publish date 903d, author information 903e, as well as a link to more information 903f from the network 100 showing the author's credentials, other verified articles written and published by the author, and inquiries or other updates on article status.

In some embodiments, an app popup 904 showing when content is clicked may provide more information about an article. The popup 904 may include an article identification number 904a, an article published date 904b, author name information 904c, and co-author, entity or cross-signer information 904d.

In some embodiments, a webpage popup 905 may be displayed when more information is requested. This may give complete reference and background information about an article. It may include a lookup title 905a, article and author information 905b, as well as other information 905c including other articles written by the author, similar articles, or anything else pertinent to viewing the credibility of content verified by the network 100.

The present invention further relates to improvements and extensions of digital signature and authentication systems, particularly building upon an existing patented framework for content verification and user authentication.

The invention discloses several enhancements to a previously patented digital signature system, including:
1. Inline encryption using an author's key for selective content visibility
2. User authentication for online systems using digital signatures
3. Video/audio streaming encoding with incremental checksums
4. Permissions control for co-signing and cross-signing
5. Cryptographically altered borders for enhanced security
6. Author image embedding in borders
7. Moving borders for increased security
8. Handwriting-based signature key generation

The present invention further discloses enhancement in the field of inline encryption. This enhancement allows for selective content visibility within a document. Using the author's key, specific portions of content can be encrypted inline, allowing only authorized individuals or groups to view the protected information. By using User Authentication techniques, the invention proposes using the existing patented system's principles for authenticating users on websites and other online platforms. This method would provide cryptographic proof of identity, offering higher security than traditional password-based systems.

In the field of encoding of video/audio streaming, the current invention introduces a method for creating checksums on buffered segments of streaming data. This allows for continuous verification of content integrity during streaming, as opposed to only verifying the entire file upon complete download.

In the field of permission and co-signing/cross-signing, the current invention discloses a system for authors to specify who is allowed to co-sign or cross-sign their content, providing greater control over content authentication and collaboration.

The current invention also discloses the capability of cryptographically changing border. This enhancement alters the border of the signed content in a color or graphical way based on the article's signature. This ensures that no two borders are the same and cannot be easily replicated, adding an additional layer of security.

The current invention also discloses author image embedding. This feature allows for the embedding of an author's image into the border, providing quick visual identification of the content creator.

The current invention also discloses the capability to move borders. The invention proposes a moving border to enhance security further, making it more difficult to forge or replicate the authentication visual elements.

In addition, the current invention allows for handwriting signature key generation. This feature generates a cryptographic key based on an author's handwritten signature, considering factors such as line length, angles, curves, and colors. This can be used as an alternative or addition to traditional password-based keys.

1. A method for enhancing digital content authentication, comprising:
a) receiving digital content from an author;
b) generating a digital signature for the content using an existing patented framework;
c) applying at least one enhancement selected from the group consisting of:
i) inline encryption of portions of the content using the author's key;
ii) generating a user authentication token for online systems;
iii) creating incremental checksums for streaming video or audio content;
iv) applying permissions for co-signing and cross-signing;
v) generating a cryptographically changing border;
vi) embedding an author's image in the border;
vii) implementing a moving border; and
viii) generating a signature key based on the author's handwriting; and
d) associating the enhanced digital signature with the content.

2. The method of claim 1, wherein the inline encryption comprises:
a) identifying portions of the content to be encrypted;
b) encrypting the identified portions using the author's key; and
c) specifying individuals or groups authorized to view the encrypted portions.

3. The method of claim 1, wherein generating a user authentication token comprises:
a) creating a digital signature using the author's identifying information;
b) transmitting the digital signature to a server for verification; and
c) granting access to an online system upon successful verification.

4. The method of claim 1, wherein creating incremental checksums comprises:
a) dividing streaming content into buffered segments;
b) generating a checksum for each buffered segment; and
c) appending checksums to allow continuous verification during streaming.

5. The method of claim 1, wherein applying permissions for co-signing and cross-signing comprises:
a) receiving from the author a list of authorized co-signers or cross-signers;
b) verifying the identity of a co-signer or cross-signer against the authorized list; and
c) allowing or denying co-signing or cross-signing based on the verification.

6. The method of claim 1, wherein generating a cryptographically changing border comprises:
a) using the digital signature of the content to generate unique border characteristics;
b) altering the color or graphical elements of the border based on the generated characteristics; and
c) ensuring no two borders are identical.

7. The method of claim 1, wherein embedding an author's image in the border comprises:
a) receiving an image of the author;
b) resizing or modifying the image to fit within the border; and
c) integrating the image into the border design.

8. The method of claim 1, wherein implementing a moving border comprises:
a) generating a series of border designs based on the content's digital signature;
b) cycling through the series of border designs at predetermined intervals.

9. The method of claim 1, wherein generating a signature key based on the author's handwriting comprises:
a) capturing the author's handwritten signature;
b) analyzing characteristics of the signature including line lengths, angles, curves, and colors;
c) generating a unique cryptographic key based on the analyzed characteristics; and
d) using the generated key for content signing or encryption.

10. A system for implementing the method of claim 1, comprising:
a) a processor;
b) a memory storing instructions that, when executed by the processor, perform the steps of the method of claim 1.
